(19) United States
(12) Patent Application Publication
(10) Pub. No.: US 2007/0285588 A1
(43) Pub. Date: Dec. 13, 2007

(54) Light diffuser plate

(75) Inventors: Shen-Yin Tsai, Tainan City (TW); Hsi-Hsin Shih, Taichung City (TW); Shih-Kai Cheng, Yi Lan City (TW); Chin-Lung Kuo, Taiwan City (TW)

Correspondence Address: CURATOLO SIDOTI CO., LPA, 24500 CENTER RIDGE ROAD, SUITE 280, CLEVELAND, OH, 44145, US

(73) Assignee: Chi Lin Technology Co., Ltd., Jen Te Hsiang (TW)

(21) Appl. No.: 11/800,887

(22) Filed: May 8, 2007

(30) Foreign Application Priority Data
May 29, 2006 (TW) 095119037

(51) Int. Cl. G02F 1/1335

(52) U.S. Cl. 349/5

(57) ABSTRACT

A light diffuser plate includes: a diffuser film having a light incident surface and a light exit surface opposite to the light incident surface; a plurality of light-scattering particles dispersed in the diffuser film; and a light-enhancing film formed on the light exit surface of the diffuser film and having a light emerging surface opposite to the light exit surface and formed with a plurality of protrusions. The light exit surface of the diffuser film is uneven.

### CROSS-REFERENCE TO RELATED APPLICATION

This application claims priority of Taiwanese Application No. 095119037, filed on May 29, 2006.

### BACKGROUND OF THE INVENTION

1. Field of the Invention

This invention relates to a light diffuser plate, more particularly to a light diffuser plate including a diffuser film with an uneven light exit surface.

2. Description of the Related Art

A backlight module is one of the key components for making a liquid crystal display, and serves to provide a uniform light source for enabling the display of an image on a liquid crystal panel. Based on the disposition of the light source, backlight modules can be classified into a bottom lighting type and a side lighting type. The bottom lighting type normally includes a diffuser plate and optical elements, such as diffusing sheets and brightness-enhancing sheets, for enhancing the uniformity and brightness of the light emerging from the diffuser plate. FIG. 1 illustrates a conventional light diffuser plate that includes a diffuser film 11, light-scattering particles 112 dispersed in the diffuser film 11 for scattering light passing therethrough, and a light-enhancing film 12 formed on an even surface 113 of the diffuser film 11 and formed with a plurality of protrusions 122. As such, the diffuser plate thus formed can provide light scattering effect via the light-scattering particles 112. However, the light-scattering particles 112 can absorb a significant portion of the energy of the light passing through the diffuser plate, which results in a decrease in the intensity of the light emerging from the diffuser plate and undesired shifting in color.

### SUMMARY OF THE INVENTION

Therefore, the object of the present invention is to provide a light diffuser plate that can overcome the aforesaid drawback of the prior art.

According to this invention, there is provided a light diffuser plate that comprises: a diffuser film having a light incident surface and a light exit surface opposite to the light incident surface; a plurality of light-scattering particles dispersed in the diffuser film; and a light-enhancing film formed on the light exit surface of the diffuser film and having a light emerging surface opposite to the light exit surface and formed with a plurality of protrusions. The light exit surface of the diffuser film is uneven.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a fragmentary sectional view of a conventional light diffuser plate;

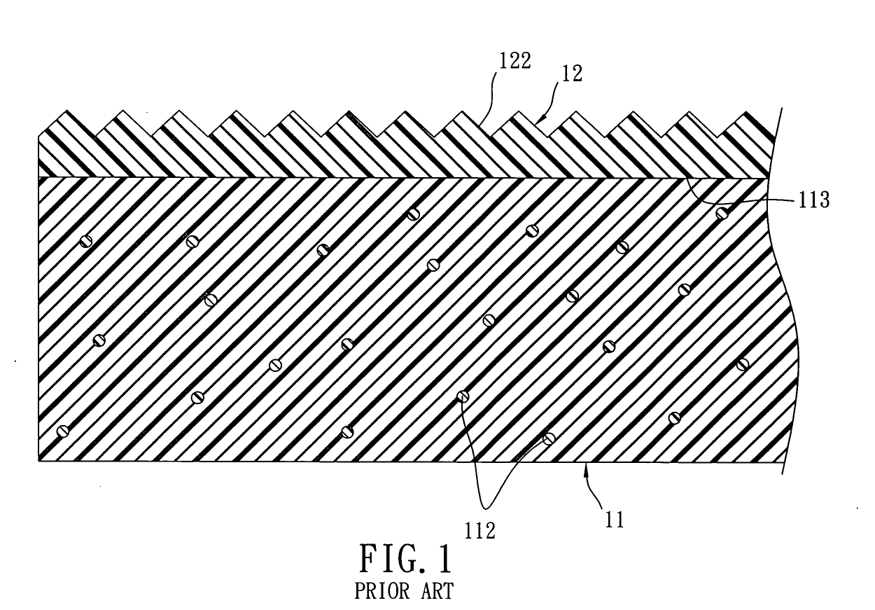

FIG. 2 is a fragmentary sectional view of the first preferred embodiment of a light diffuser plate according to this invention;

FIG. 3 is a fragmentary sectional view of the second preferred embodiment according to this invention; and

FIG. 4 is a fragmentary sectional view of the third preferred embodiment according to this invention.

### DETAILED DESCRIPTION OF THE PREFERRED EMBODIMENTS

Before the present invention is described in greater detail, it should be noted that same reference numerals have been used to denote like elements throughout the specification.

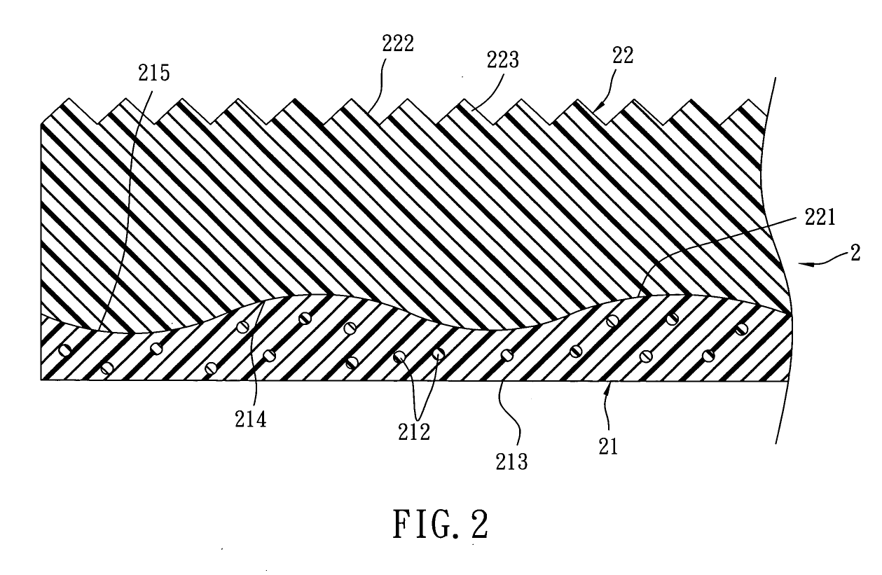

FIG. 2 illustrates the first preferred embodiment of a light diffuser plate 2 according to this invention for a backlight module.

The light diffuser plate 2 includes: a diffuser film 21 having a light incident surface 213 and a light exit surface 214 opposite to the light incident surface 213; a plurality of light-scattering particles 212 dispersed in the diffuser film 21; and a light-enhancing film 22 formed on the light exit surface 214 of the diffuser film 21 and having a light emerging surface 222 opposite to the light exit surface 214 and formed with a plurality of protrusions 223. The light exit surface 214 of the diffuser film 21 is uneven.

In this embodiment, the light exit surface 214 of the diffuser film 21 has a wavelike profile which includes a series of connected ripples 215, each of which is curved in shape. The light-enhancing film 22 has a contact surface 221 that is opposite to the light emerging surface 222 and that conforms to the light exit surface 214 of the diffuser film 21.

The diffuser film 21 is made from a polymer material, while the light-scattering particles 212 are made from a material having a refractive index different from that of the polymer material. The difference in refractive index between the material of the light-scattering particles 212 and the polymer material preferably ranges from 0.01 to 0.2. The diffuser film 21 has a thickness ranging from 0.1 mm to 1 mm. The protrusions 223 of the light-enhancing film 22 are preferably prismatic in shape.

Preferably, the polymer material is selected from the group consisting of polymethylmethacrylate, polycarbonate, polymethylmethacrylate styrene copolymer, metallocene cycloolefin copolymer, polystyrene, and polymethylpentene. The light-enhancing film 22 is preferably made from the polymer material.

Preferably, the light-scattering particles 212 are present in an amount ranging from 0.01 wt % to 10 wt % based on the total weight of the diffuser film 21 and the light-scattering particles 212.

Alternatively, each of the ripples 215 of the wavelike profile of the light exit surface 214 of the diffuser film 21 can be semi-circular, prismatic, or cylindrical in shape. The wavelike profile of the light exit surface 214 of the diffuser film 21 is preferably a sinusoidal wave.

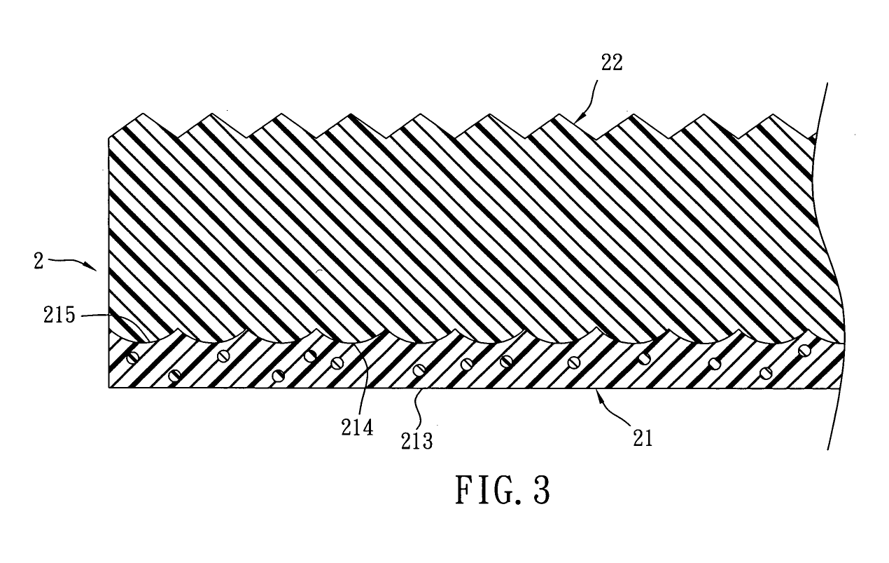

FIG. 3 illustrates the second preferred embodiment of the light diffuser plate 2 according to this invention. The light diffuser plate 2 of this embodiment differs from the previous embodiment in that the wavelike profile of the light exit surface 214 of the diffuser film 21 is a sinusoidal wave, and that each of the ripples 215 of the wavelike profile of the light exit surface 214 of the diffuser film 21 is semi-circular in shape.

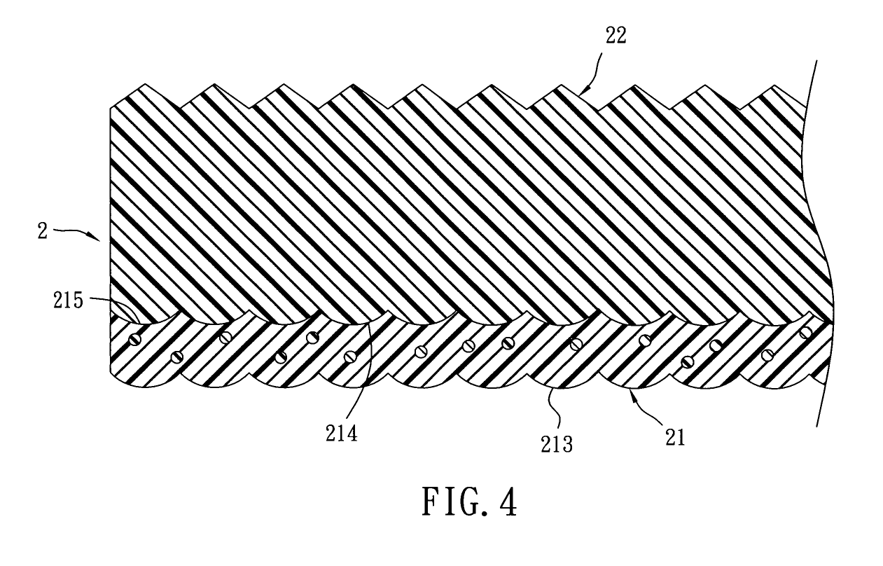

FIG. 4 illustrates the third preferred embodiment of the light diffuser plate 2 according to this invention. The light diffuser plate 2 of this embodiment differs from the second preferred embodiment in that the light incident surface 213 of the diffuser film 21 is also uneven and has a wavelike profile similar to that of the light exit surface 214 of the diffuser film 21.

By virtue of the uneven light exit surface 214 of the diffuser film 21, the amount of the light-scattering particles 212 present in the diffuser film 21 can be considerably reduced while achieving the same light scattering effect, thereby eliminating the aforesaid drawback associated with the prior art. Moreover, the layer thickness of the diffuser film of the conventional light diffuser plate is about 4 to 12 times of the light-enhancing film of the conventional diffuser plate, while that of the diffuser film 21 of the light diffuser plate 2 of this invention is about one third of the light-enhancing film 22 of the diffuser plate 2 of this invention for achieving the same light scattering effect. Hence, the layer thickness of the diffuser film 21 can be significantly reduced to achieve the same light scattering effect as compared to the aforesaid conventional diffuser plate.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A light diffuser plate comprising:
a diffuser film having a light incident surface and a light exit surface opposite to said light incident surface;
a plurality of light-scattering particles dispersed in said diffuser film; and
a light-enhancing film formed on said light exit surface of said diffuser film and having a light emerging surface opposite to said light exit surface and formed with a plurality of protrusions;
wherein said light exit surface of said diffuser film is uneven.

2. The light diffuser plate of claim 1, wherein said light exit surface of said diffuser film has a wavelike profile.

3. The light diffuser plate of claim 2, wherein said wavelike profile of said light exit surface of said diffuser film includes a series of connected ripples, each of which is semi-circular in shape.

4. The light diffuser plate of claim 1, wherein said light enhancing film has a contact surface that is opposite to said light emerging surface and that conforms to said light exit surface of said diffuser film.

5. The light diffuser plate of claim 1, wherein said light incident surface of said diffuser film has a wavelike profile.

6. The light diffuser plate of claim 1, wherein said diffuser film has a thickness ranging from 0.1 mm to 1 mm.

7. The light diffuser plate of claim 1, wherein said diffuser film is made from a polymer material, said light-scattering particles being made from a material having a refractive index different from that of said polymer material, the difference in refractive index between said material of said light-scattering particles and said polymer material ranging from 0.01 to 0.2.

8. The light diffuser plate of claim 1, wherein said polymer material is selected from the group consisting of polymethylmethacrylate, polycarbonate, polymethylmethacrylate styrene copolymer, metallocene cycloolefin copolymer, polystyrene, and polymethylpentene.

9. The light diffuser plate of claim 1, wherein said light-scattering particles are present in an amount ranging from 0.01 wt % to 10 wt % based on the total weight of said diffuser film and said light-scattering particles.

10. The light diffuser plate of claim 1, wherein said protrusions of said light-enhancing film are prismatic in shape.
